(19) United States
(12) Patent Application Publication
(10) Pub. No.: US 2014/0351778 A1
(43) Pub. Date: Nov. 27, 2014

(54) LSI DESIGN APPARATUS AND METHOD OF DESIGNING LSI

(71) Applicant: KABUSHIKI KAISHA TOSHIBA, Tokyo (JP)

(72) Inventors: Takeki OSANAI, Yokohama-shi (JP); Makoto Ichida, Yokohama-shi (JP)

(73) Assignee: KABUSHIKI KAISHA TOSHIBA, Tokyo (JP)

(21) Appl. No.: 13/898,735

(22) Filed: May 21, 2013

(51) Int. Cl. G06F 17/50

(52) U.S. Cl. CPC G06F 17/5031
USPC 716/113

(57) ABSTRACT

According to one embodiment, a LSI design apparatus includes a first logic synthesis portion executing a design of a LSI in a logic gate level, a extraction portion extracting paths from the LSI, a determination portion determining a character of each of the paths, a parameter setting portion setting an upper limit of a transition time of a signal on each of the paths independently based on the character of each of the paths, and a second logic synthesis portion revising the design of the LSI generated in the first logic synthesis portion by optimizing each of the paths so that each of the paths satisfies the upper limit of the transition time of the signal.

### CROSS-REFERENCE TO RELATED APPLICATIONS

This application claims the benefit of U.S. Provisional Application No. 61/790,615, filed Mar. 15, 2013, the entire contents of which are incorporated herein by reference.

### FIELD

Embodiments described herein relate generally to a LSI design apparatus and a method of designing a LSI.

### BACKGROUND

There is an LSI design technique for: dividing an LSI into multiple blocks; designing each block; and then connecting these blocks through global wires.

### BRIEF DESCRIPTION OF THE DRAWINGS

FIG. 1 is a diagram depicting a CAD apparatus;

FIG. 2 is a flowchart depicting an operation of the CAD apparatus of FIG. 1;

FIG. 3 is a diagram depicting information in a storage unit of FIG. 1;

FIG. 4 is a flowchart depicting an operation of the CAD apparatus of FIG. 1;

FIGS. 5A and 5B are diagrams depicting a transition time of a signal in a path;

FIG. 6 is a diagram depicting an example of a design unit;

FIG. 7 is a diagram depicting a design tool of Example;

FIG. 8 is a flowchart depicting an operation of changing a parameter, based on a character of a path; and

FIG. 9 is a diagram depicting a floor plan of a logic LSI as an application example.

### DETAILED DESCRIPTION

In general, according to one embodiment, a LSI design apparatus comprising: a first logic synthesis portion executing a design of a LSI in a logic gate level; an extraction portion extracting paths from the LSI; a determination portion determining a character of each of the paths; a parameter setting portion setting an upper limit of a transition time of a signal on each of the paths independently based on the character of each of the paths; and a second logic synthesis portion revising the design of the LSI generated in the first logic synthesis portion by optimizing each of the paths so that each of the paths satisfies the upper limit of the transition time of the signal.

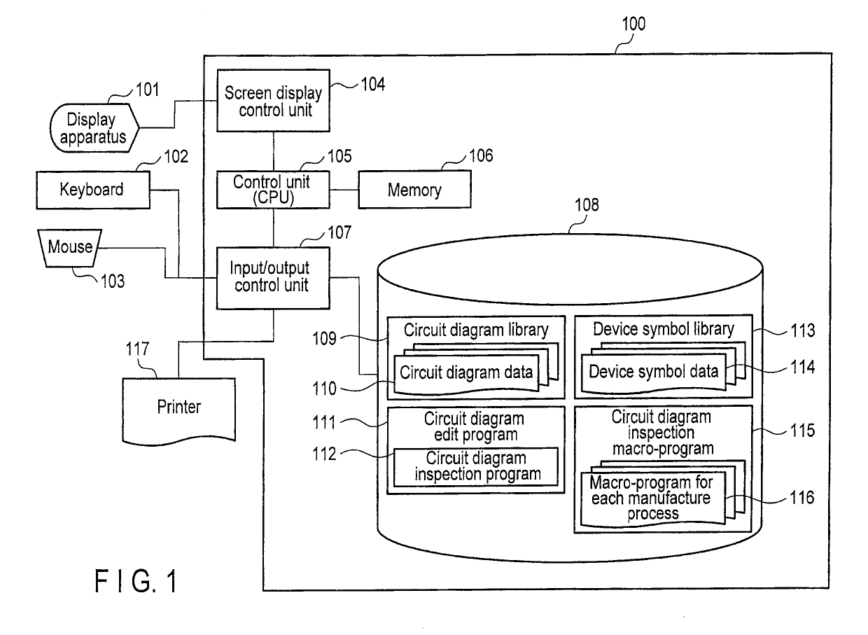

FIG. 1 depicts a CAD apparatus as a design tool for an LSI.

A CAD apparatus 100 is connected to a display apparatus 101, a keyboard 102, a mouse 103, and a printer 117. The CAD apparatus 100 includes a screen display control unit 104, a control unit (CPU) 105, a memory 106, an input/output control unit 107, and a storage unit 108. The CAD apparatus 100 causes the display apparatus 101 to display a predetermined screen, and receives an operator's instruction through the keyboard 102 or the mouse 103.

The storage unit 108 memorizes: a circuit diagram library 109 storing circuit diagram data 110; a circuit diagram edit program 111 including a circuit diagram inspection program 112; a device symbol library 113 storing device symbol data 114 which the circuit diagram library 109 refers to; and a circuit diagram inspection macro-program 115 storing a macro-program 116 for each fabrication process.

The circuit diagram data 110 is data of a designed circuit diagram. The circuit diagram inspection program 112 is a program for inspecting the designed circuit diagram. The device symbol data 114 is data representing a symbol of a device that is a basic unit for a design. The macro-program for each manufacture process is a program that inspects whether or not a predetermined condition is satisfied, in each fabrication process.

The control unit 105 reads the circuit diagram edit program 111 in the memory 106 in accordance with an operator's instruction that has been received through the keyboard 102 or the mouse 103, and executes the circuit diagram edit program 111. Once the circuit diagram edit program 111 is executed and a predetermined command is given to the circuit diagram edit program 111, the CAD apparatus 100 is activated.

The CAD apparatus 100 may be activated through inputting of a text command to the circuit diagram edit program 111 or a graphical user interface for a command selection which the circuit diagram edit program 111 causes the display apparatus 101 to display.

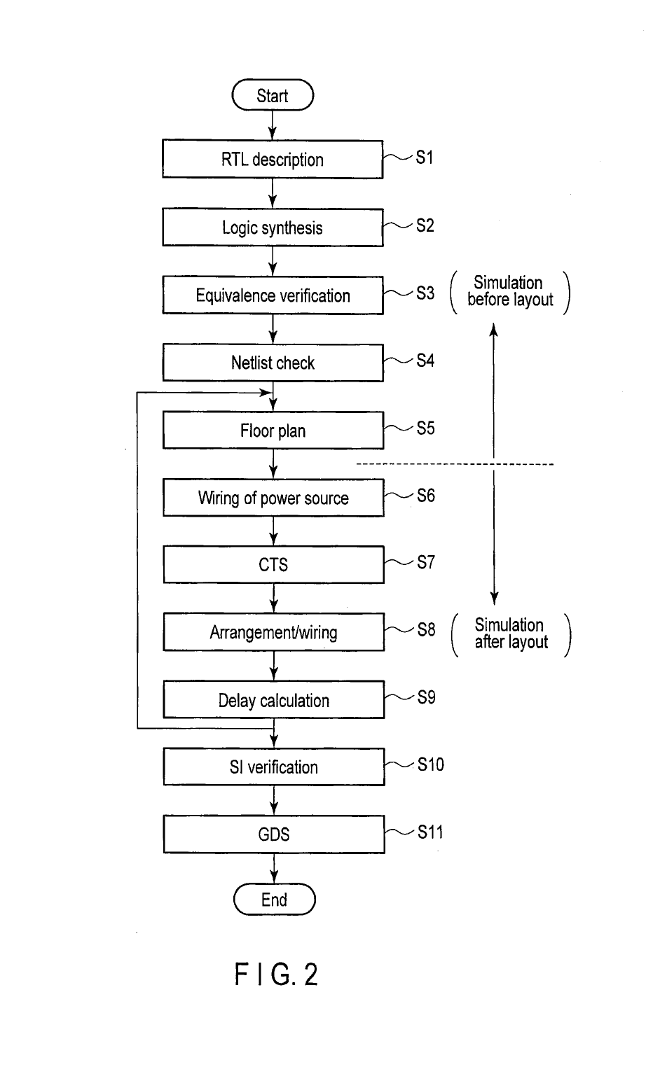

FIG. 2 depicts an operation of the CAD apparatus of FIG. 1.

First, RTL (register transfer level) descriptions using an HDL (hardware description language) are synthesized by a description of a software program, based on information regarding a system design (Step S1).

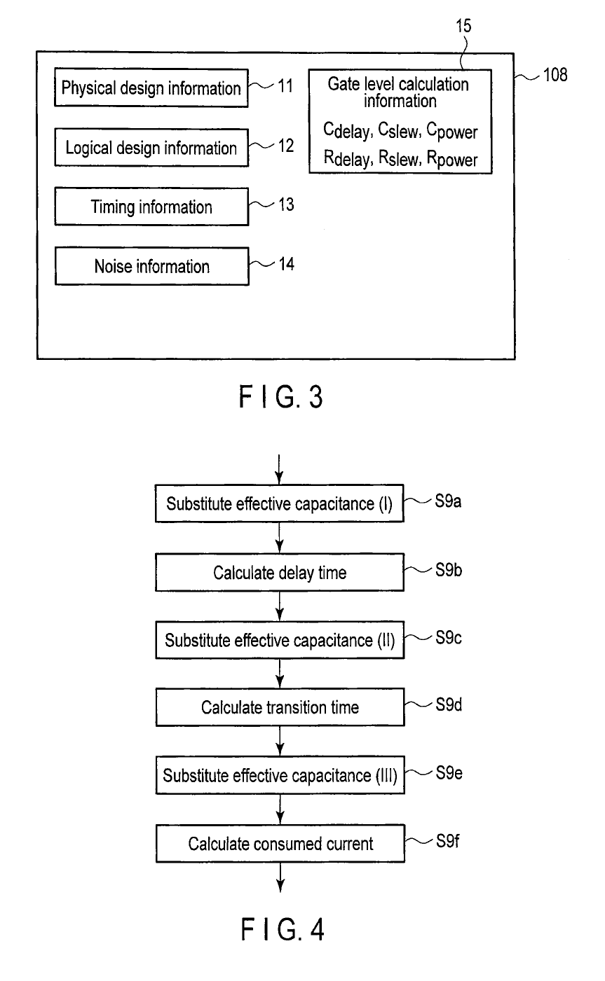

Then, LSIs on the logic gate level are synthesized based on the RTL description. Specifically, as depicted in FIG. 3, the logic synthesis is made by using information in the storage unit 108 that stores: physical design information 11; logical design information 12; timing information 13; noise information 14; gate level calculation information 15, and the like (Step S2).

The physical design information 11 is information on a physical position of a circuit to be designed. The logical design information 12 is information indicating logic to be designed. The timing information 13 is information regarding a timing of signals passing through a circuit to be designed. The noise information 14 is information regarding a noise generated in a circuit to be designed. For example, ALF (advanced library format) may be used as the above information.

The gate level calculation information 15 is information for calculating various characteristics of a circuit to be designed. The various characteristics include a logic gate's delay effective capacitance Cdelay, transition effective capacitance Cslew, consumed current effective capacitance Cpower, delay effective resistance Rdelay, transition effective resistance Rslew, and consumed current effective resistance Rpower.

The logic gate delay effective capacitance Cdelay is a capacitance affecting the delay of a signal passing through a logic gate. The transition effective capacitance Cslew is a capacitance affecting the transition of a signal in a logic gate. The consumed current effective capacitance Cpower is a capacitance affecting a consumed current flowing through a logic gate. The delay effective resistance Rdelay is a resistance affecting the delay of a signal passing through a logic gate. The transition effective resistance Rslew is a resistance affecting the transition of a signal in a logic gate. The consumed current effective resistance Rpower is a resistor affecting a consumed current flowing through a logic gate.

The delay effective capacitance Cdelay, the transition effective capacitance Cslew, the consumed current effective capacitance Cpower, and an effective resistance Rjk are individually set for each logic gate circuit. Each of these values differs depending on a logic gate circuit and a supply voltage of this logic gate.

It is desirable that the delay effective capacitance Cdelay, the transition effective capacitance Cslew, the consumed current effective capacitance Cpower, the delay effective resistance Rdelay, the transition effective resistance Rslew, the consumed current effective resistance Rpower be subjected to fitting with an evaluated prototype logical gate in advance.

It is verified whether or not the designed circuit exhibits a correct logic, by using a logic simulator, a library and the like (equivalence verification). Note that an operation of verifying the timing of a signal may be performed by using the STA (static timing analysis), in addition to the above verification (Step S3).

Then, the designed circuit is subjected to the connection-related check (netlist check). Through the above steps, the layout (floor plan) of the LSI is completed (Step S4).

The wiring of a power source is determined based on the floor plan (Step S6). Moreover, CTS (clock tree synthesis) is made. The CTS is to determine the wiring of clock signals for controlling the operation of a circuit in a layout of an LSI (Step S7).

Subsequently, the arrangement and wiring of circuits in the floor plan are adjusted. In more detail, the arrangement and wiring of logic gates, such as an inverter, an AND gate, a NAND gate, an OR gate, a NOR gate, and the like, are adjusted such that the logic gates operate correctly (Step S8).

As depicted in FIG. 4, for example, for the circuit on the logic gate level which is arranged and wired, a delay, a transition time, and a consumed current are calculated (Steps S9a to S9f).

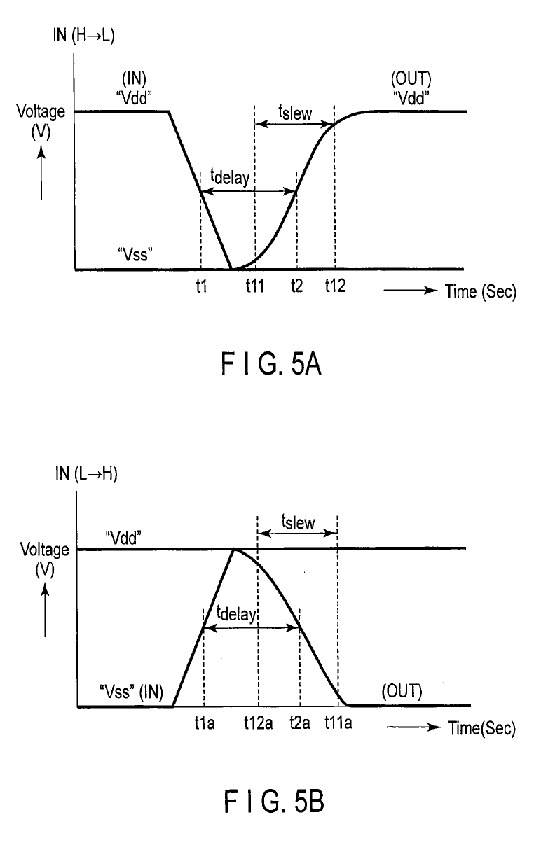

As depicted in FIG. 5A, for example, as for a waveform of an input/output signal of a logic gate, after a predetermined time elapses when an input signal IN is changed from “Vdd” into “Vss,” an output signal OUT is changed from “Vss” into “Vdd.”

Here, the “Vdd” represents a high level of a logic gate (binary signal), such as a voltage potential of a power source. The “Vss” represents a low level of a logic gate (binary signal), such as a ground voltage potential. Further, the fall time characteristic (input slew) of the input signal IN is illustrated as a linear change.

A delay time tdelay is represented by a time interval between a time t1 and a time t2. The time t1 is defined by a time at which the input signal IN becomes 50% of the “Vdd,” and the time t2 is defined by a time at which the output signal OUT becomes 50% of the “Vdd.” A transition time tslew of a signal is represented by a time interval between a time t11 and a time t12. The time t11 is defined by a time at which the output signal OUT becomes 10% of the “Vdd,” and the time t12 is defined by a time at which the output signal OUT becomes 90% of the “Vdd.” As depicted in FIG. 5B, for example, as for a waveform of an input/output signal of a logic gate, after a predetermined time elapses when an input signal IN is changed from “Vss” into “Vdd,” an output signal OUT is changed from “Vdd” into “Vss.”

Here, the “Vdd” and “Vss” are the same as those of FIG. 5A, respectively. Further, the rise time characteristic (input slew) of the input signal IN is illustrated as a linear change.

A delay time tdelay is represented by a time interval between a time t1a and a time t2a. The time t1a is defined by a time at which the input signal IN becomes 50% of the “Vdd,” and the time t2a is defined by a time at which the output signal OUT becomes 50% of the “Vdd.” A transition time tslew of a signal is represented by a time interval between a time t12a and a time t11a. The time t12a is defined by a time at which the output signal OUT becomes 90% of the “Vdd,” and the time t11a is defined by a time at which the output signal OUT becomes 10% of the “Vdd.” In Example, a longer limit of the transition time tslew, as described above, of a signal is optimized as a parameter (or a constraint for verifying a circuit) given to the CAD apparatus which has been described in FIGS. 1, 2, 3, 4, 5A and 5B, depending on a character of each path in an LSI, namely, whether each path is a gate-delay dominant path or a wire-delay dominant path.

Hereinafter, Example of this optimization will be described.

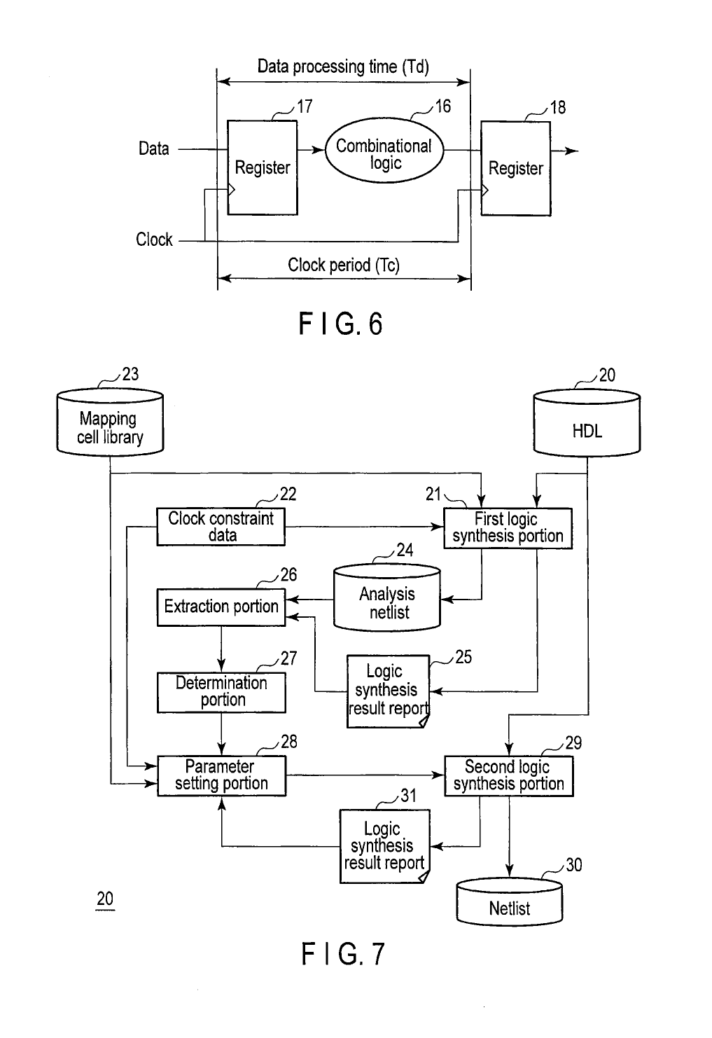

FIG. 6 depicts a configuration of an LSI as a design target.

As depicted in FIG. 6, combinational logic 16 is disposed between two registers (or two flip-flops) 17 and 18. Specifically, a path in the LSI which is verified by using a longer limit of a transition time tslew of a signal corresponds to an interval between the two registers 17 and 18.

Data is input to the register 17 in synchronization with a clock signal. Then, the combinational logic 16 processes the signal within a clock period Tc, and this result is input to the register 18. In this case, a time Td devoted to the data processing is required to be shorter than the clock period Tc. In other words, the clock period Tc and the data processing time Td need to satisfy a relationship of Tc>Td.

FIG. 7 depicts an optimization of a longer limit of a transition time of a signal.

A first logic synthesis portion 21 designs an LSI on the logic gate level, by referring to a mapping cell library 23 based on circuit information 20 described with the HDL, and outputs an analysis netlist 24 and a logic synthesis result report 25. In this case, the first logic synthesis portion 21 designs the LSI on the logic gate level, based on a constraint excluding a longer limit of a transition time of a signal, such as a clock constraint data 22.

An extraction portion 26 extracts all paths from the LSI, based on the analysis netlist 24 and the logic synthesis result report 25 that are generated by the first logic synthesis portion 21. A determination portion 27 determines a character of each of all the extracted paths, namely, whether each path is a gate-delay dominant path or a wire-delay dominant path.

A parameter setting portion 28 independently sets longer limits of transition times of the paths (constraints for verifying a circuit), based on the characteristics of the paths.

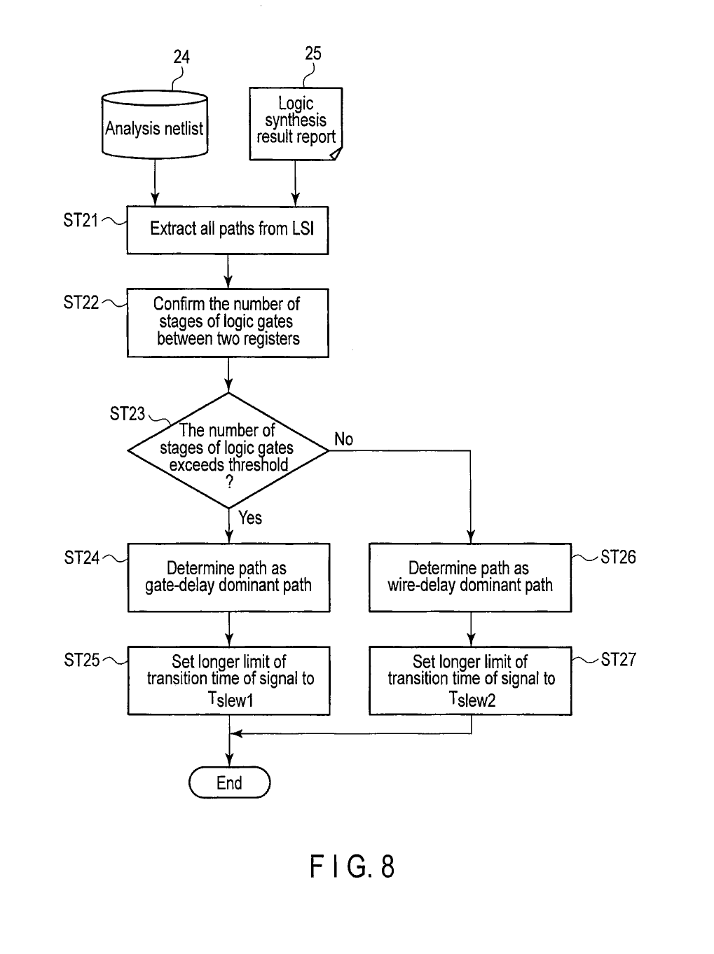

FIG. 8 depicts processing performed by the extraction portion 26, the determination portion 27, and the parameter setting portion 28.

First, all the paths are extracted from the LSI generated by the logic synthesis, based on the analysis netlist 24 and the logic synthesis result report 25 (Step ST21).

Then, the number of stages of logic gates s excluding an inverter and a buffer is confirmed between two registers in each path (Step ST22).

It is determined whether or not the number of stages of the logic gates s exceeds a threshold (Step ST23).

If the number of the stages of the logic gates s exceeds the threshold, the corresponding path is recognized to be a gate-delay dominant path (Step ST24), and a longer limit of a transition time of a signal is set to Tslew1 (Step ST25).

Otherwise, if the number of stages of the logic gates s does not exceed the threshold, the corresponding path is recognized to be a wire-delay dominant path (Step ST26), and a longer limit of a transition time of a signal is set to Tslew2 (Step ST27).

Thus, Tslew1<Tslew2 is satisfied. Through the above steps, a longer limit of a transition time of a signal is newly determined for each path, based on a character of each path in the LSI generated by the logic synthesis.

Subsequently, a second logic synthesis portion 29 re-designs the LSI on the logic gate level, by referring to the mapping cell library 23 based on the circuit information 20, similar to the first logic synthesis portion 24.

In this case, the second logic synthesis portion 29 revises the LSI generated by the first logic synthesis portion 21, while optimizing each path in the LSI in such a way that each path satisfies the parameter (or the constraint) set by the parameter setting portion 28, namely, the longer limit of the transition time of the signal.

The second logic synthesis portion 29 outputs a netlist 30 and a logic synthesis result report 26.

According to Example, first, the first logic synthesis portion 21 designs an LSI on the logic gate level, in such a way that each path of the LSI at least satisfies a parameter excluding a longer limit of a transition time of a signal (relaxed constraint). Subsequently, a longer limit of a transition time of a signal is determined based on a result of a logic synthesis made by the first logic synthesis portion 24. Then, the second logic synthesis portion 29 revises the LSI generated by the first logic synthesis portion 21, in such a way that each path of the LSI satisfies the above parameter (or constraint).

In this case, a basic performance of a path can be known from the result of the logic synthesis made by the first logic synthesis portion 21. Then, the second logic synthesis portion 29 revises the LSI generated by the first logic synthesis portion 21 in such a way that each path of the LSI satisfies the longer limit of the transition time of the signal. This processing makes it possible to design and verify an LSI promptly whose design result is optimized in accordance with a character of each path.

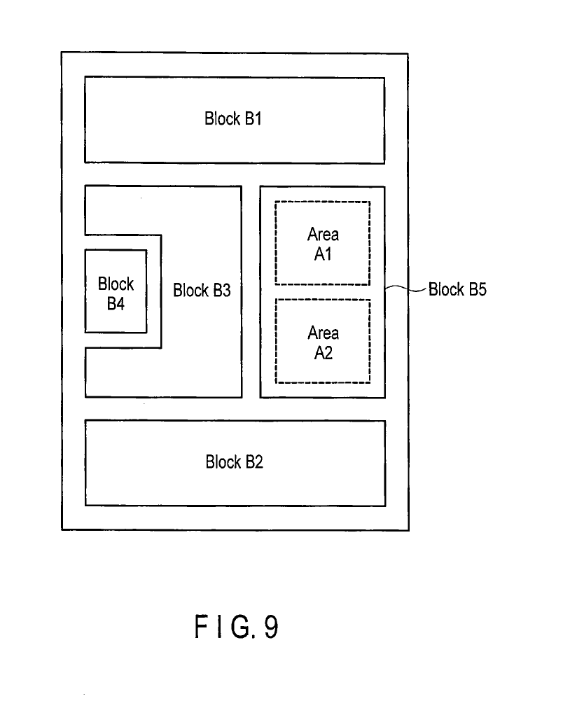

FIG. 9 depicts an example of design units in an LSI.

FIG. 9 depicts an example of a floor plan of a logic LSI such as a microcomputer, a memory controller, or the like. A chip area is separated into blocks B1 to B5, and for example, each individual block is designed by using the CAD apparatus.

In this case, a parameter (or a constraint), which is a longer limit of a transition time of a signal, is set in accordance with a character of each path in the blocks B1 to B5.

For example, there are cases where two areas A1 and A2 in the block B5 operate at different frequencies.

In this case, a condition of a transition time of each path in the area A1 of the block B5 can be set so as to differ from that in the area A2 of the block B5.

The Example described above is summed up.

For example, in the case where an LSI is designed which includes multiple modules connected to a system bus and communicating with one another, a gate-delay dominant path and a wire-delay dominant path that will be described below are present in the LSI.

For example, it is known that a delay time of the gate of an FET constituting logic is dependent on a waveform of an input signal. For this reason, a parameter by which a gate delay is decreased, namely, a longer limit of a transition time tslew of a signal is decreased needs to be set for a critical path having many logic stages. This setting achieves a high speed operation of a logic circuit.

Such a path is called as a gate-delay dominant path.

Meanwhile, when an LSI is designed, a path with a long wire is created. For such a path, a technique for separating a capacitance (CR time constant) of the wire by splitting the wire with a repeater buffer, an inverter and the like is employed. However, if a parameter optimized for a path having many logic stages is employed, the number of repeater buffers, inverters and the like to be inserted into the wire is excessively increased. As a result, a high speed operation of a logic circuit is suppressed.

Accordingly, a parameter by which a longer limit of a transition time tslew of a signal is increased needs to set for a path having a long wire.

Such a path is called as a wire-delay dominant path.

When an LSI can be designed collectively in the above manner, an optimum parameter, or a longer limit of a transition time tslew of a signal, given to the design tool differs, depending on a character of each path in the LSI.

Therefore, it is important to change an optimum parameter of each path in the LSI given to the design tool, such as a longer limit of a transition time of a signal, depending on a character of each path, namely, whether each path is a gate-delay dominant path or a wire-delay dominant path.

Specifically, an LSI on the logic gate level is designed based on an RTL (register transfer level) description with the HDL (hardware description language). Subsequently, it is determined whether each path in the designed LSI is a wire-delay dominant path or a gate-delay dominant path. Followed by, a path that has been determined as a gate-delay dominant path is set such that a longer limit of a transition time tslew of a signal is decreased, whereas a path that has been determined as a wire-delay dominant path is set such that a longer limit of a transition time tslew of a signal is increased. Finally, each path in this state is verified.

Consequently, in Example, a longer limit of a transition time tslew of a signal in a wire-delay dominant path is set higher than that of a gate-delay dominant path.

In this case, a character of each path may be determined by using, for example, the number of stages of logic gates between two flip-flop circuits as a threshold. However, it should be noted that an inverter and a buffer are not included in the logic gate in Example. If the number of stages of logic gates exceeds the threshold, the gate is determined as a gate-delay dominant path. Otherwise, if the number of stages of logic gates does not exceed the threshold, the gate is determined as a wire-delay dominant path.

Alternatively, a character of each path may be determined based on a type of a wiring layer which each path belongs to. In this case, respective longer limits of transition times of signals in multiple paths are determined based on types of wiring layers which these paths belong to.

For example, when a wiring layer which a path belongs to has a time constant that exceeds a predetermined value, this path is determined as a wire-delay dominant path, and a longer limit of a transition time of a signal in this path is set to a large value. Meanwhile, when a wiring layer which a path belongs to has a time constant that does not exceed a predetermined value, this path is determined as a gate-delay dominant path and a longer limit of a transition time of a signal in this path is set to a small value.

In Example, the path corresponds to an interval in which data is processed within one or more periods of a clock, and includes any interval in a whole LSI or any block thereof.

With Example described above, a design result can be optimized for each character of a path.

The optimization based on the difference between the gate-delay dominant path and the wire-delay dominant path is at least effective in designing LSIs with 10M-gates which are operable at an approximately 200 MHz and to which 40 nm process technology is applied. It is believed that the above optimization will still produce a significant effect even if the process technology advances in the future and the design of LSIs is scaled up more than the above design.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A LSI design apparatus comprising:
a first logic synthesis portion executing a design of a LSI in a logic gate level;
a extraction portion extracting paths from the LSI;
a determination portion determining a character of each of the paths;
a parameter setting portion setting an upper limit of a transition time of a signal on each of the paths independently based on the character of each of the paths; and
a second logic synthesis portion revising the design of the LSI generated in the first logic synthesis portion by optimizing each of the paths so that each of the paths satisfies the upper limit of the transition time of the signal.

2. The apparatus of claim 1,
wherein each of the paths is an interval which is executed a process in one or more periods of a clock.

3. The apparatus of claim 1,
wherein each of the paths is an interval between two registers.

4. The apparatus of claim 3,
wherein the character of each of the paths is determined by stages of logic gates except an inverter and a buffer between the two registers.

5. The apparatus of claim 4,
wherein the upper limit of the transition time of the signal of each of the paths is determined by whether a number of the stages of the logic gates between the two registers are larger than a threshold value.

6. The apparatus of claim 5,
wherein the upper limit of the transition time of the signal is set a first value when the number of the stages of the logic gates is larger than the threshold value, and
the upper limit of the transition time of the signal is set a second value larger than the first value when the number of the stages of the logic gates is smaller than the threshold value.

7. The apparatus of claim 1,
wherein the upper limit of the transition time of the signal of each of the paths is determined based on a kind of a wiring layer in which each of the paths belongs.

8. The apparatus of claim 7,
wherein the upper limit of the transition time of the signal is set a first value when the wiring layer has a time constant smaller than the predetermined value, and
the upper limit of the transition time of the signal is set a second value larger than the first value when the wiring layer has a time constant larger than the predetermined value.

9. The apparatus of claim 1,
wherein the first logic synthesis portion executes the design in the logic gate level based on a parameter except the upper limit of the transition time of the signal.

10. The apparatus of claim 1,
wherein each of the first and second logic synthesis portions executes the design of the LSI with logic gates larger than 10 mega gates based on a RTL-description.

11. A method of designing a LSI, the method comprising:
executing a design of a LSI in a logic gate level by using a first logic synthesis portion;
extracting paths from the LSI by using a extraction portion;
determining a character of each of the paths by using a determination portion;
setting an upper limit of a transition time of a signal on each of the paths independently based on the character of each of the paths by using a parameter setting portion; and
revising the design of the LSI generated in the first logic synthesis portion by optimizing each of the paths so that each of the paths satisfies the upper limit of the transition time of the signal, by using a second logic synthesis portion.

12. The method of claim 11,
wherein each of the paths is an interval which is executed a process in one or more periods of a clock.

13. The method of claim 11,
wherein each of the paths is an interval between two registers.

14. The method of claim 13,
wherein the character of each of the paths is determined by stages of logic gates except an inverter and a buffer between the two registers.

15. The method of claim 14,
wherein the upper limit of the transition time of the signal of each of the paths is determined by whether a number of the stages of the logic gates between the two registers are larger than a threshold value.

16. The method of claim 15,
wherein the upper limit of the transition time of the signal is set a first value when the number of the stages of the logic gates is larger than the threshold value, and
the upper limit of the transition time of the signal is set a second value larger than the first value when the number of the stages of the logic gates is smaller than the threshold value.

17. The method of claim 11,
wherein the upper limit of the transition time of the signal of each of the paths is determined based on a kind of a wiring layer in which each of the paths belongs.

18. The method of claim 17,
wherein the upper limit of the transition time of the signal is set a first value when the wiring layer has a time constant smaller than the predetermined value, and
the upper limit of the transition time of the signal is set a second value larger than the first value when the wiring layer has a time constant larger than the predetermined value.

19. The method of claim 11,
wherein the first logic synthesis portion executes the design in the logic gate level based on a parameter except the upper limit of the transition time of the signal.

20. A LSI design apparatus comprising:
a first logic synthesis portion executing a design of a LSI in a logic gate level;
a parameter setting portion changing an upper limit of a transition time of a signal on a path extracting from the LSI based on a character of the path; and
a second logic synthesis portion revising the design of the LSI generated in the first logic synthesis portion so that the path satisfies the upper limit of the transition time of the signal.
